(19) United States
(12) Patent Application Publication
(10) Pub. No.: US 2013/0079223 A1
(43) Pub. Date: Mar. 28, 2013

(54) METHOD FOR PREPARING MESOPOROUS CARBON HAVING IRON OXIDE NANOPARTICLES

(71) Applicants: Yo-Han Kim, Buk-gu (KR); Hee-Chul Choi, Buk-gu (KR); Ho-Sik Park, Buk-gu (KR)

(72) Inventors: Yo-Han Kim, Buk-gu (KR); Hee-Chul Choi, Buk-gu (KR); Ho-Sik Park, Buk-gu (KR)

(73) Assignee: GWANGJU INSTITUTE OF SCIENCE AND TECHNOLOGY, Buk-gu, Gwangju (KR)

(21) Appl. No.: 13/701,978

(22) PCT Filed: Aug. 24, 2011
(86) PCT No.: PCT/KR2011/006250

§ 371 Date: Dec. 4, 2012

(30) Foreign Application Priority Data
Aug. 25, 2010 (KR) 1020100082231

(51) Int. Cl. B01J 20/20; B01J 20/32; B82Y 30/00

(52) U.S. Cl. 502/406; 977/778

(57) ABSTRACT

Provided is a method of preparing mesoporous carbon including iron oxide nanoparticles. The method of preparing mesoporous carbon including iron oxide nanoparticles according to the present invention includes (1) dispersing and saturating iron oxide nanoparticles on a surface of mesoporous carbon and (2) calcinating the mesoporous carbon. The mesoporous carbon including iron oxide nanoparticles prepared according to the present invention may exhibit very good adsorption of an organic material and may have advantages in economic factors and convenience due to a reduction in reaction time. Therefore, contaminant treatment efficiency may be maximized by applying the mesoporous carbon including iron oxide nanoparticles according to the present invention to an adsorbent for a water treatment.

### TECHNICAL FIELD

The present invention disclosed herein relates to a method of preparing mesoporous carbon including iron oxide nanoparticles, and more particularly, to a method of preparing mesoporous carbon having iron oxide nanoparticles adhered to a surface of a mesoporous carbon support.

### BACKGROUND ART

An effective removal of organic contaminants having a high molecular weight in a water treatment process has been regarded as one of essential techniques. In a typical water treatment process, activated carbon has been used in order to treat the organic contaminants. However, since the activated carbon may not be used for a long period of time, may be difficult to adsorb organic materials having various sizes, and may be refried after the treatment, secondary contamination may not only occur, but the activated carbon may also act as another contamination source when being released into a natural ecosystem. Further, since the effective removal of organic contaminants having a high molecular weight may not be performed by using a typical activated carbon technique, a membrane fouling phenomenon may occur in a subsequent membrane process. In order to overcome the foregoing limitations, mesoporous carbon materials have been on the spot light, and synthesis and surface modification of mesoporous carbon tailored for target contaminants suitable for a water treatment or techniques of removing contaminants by using the same have been reported (Hartmann et. al., 2005; Donati et. al., 2004; Nakamura et. al., 2006; Han et. al., 2003).

Meanwhile, since iron oxide abundantly exits on the earth and has a stable form, it has been used in various fields, such as catalysts, (Beltran et. al., 2005; Waychunas et. al., 2005) and has been reported as a material having adsorptivity for organic materials such as humic acid (Sander et. al., 2004). However, the use of iron oxide nanoparticles having a powder form has been limited due to the difficulties in separation and collection. In order to overcome such limitations, iron oxide nanoparticles are fixed on solid supports, such as activated carbon, alumina, and silica, by using a wet impregnation method. However, in the case that nanoparticles are adhered to a surface of the support as described above, since the nanoparticles may cause a pore blocking phenomenon of the support, physical surface characteristics of the support may be degraded. This may result in a decrease in effectiveness, such as adsorptivity and catalytic performance, and may be a main factor limiting the effective use thereof.

Therefore, there is a need for research into a technique able to effectively remove organic contaminants in the present technical field.

### DISCLOSURE

### Technical Problem

The present invention provides a method of preparing mesoporous carbon having iron oxide nanoparticles adhered thereto (MC—Fe) suitable for an adsorbent that may effectively remove organic contaminants.

### Technical Solution

In accordance with an exemplary embodiment of the present invention, a method of preparing mesoporous carbon including iron oxide nanoparticles includes:
(1) dispersing and saturating iron oxide nanoparticles on a surface of mesoporous carbon; and
(2) calcinating the mesoporous carbon.

In accordance with another exemplary embodiment of the present invention, there is provided mesoporous carbon including iron oxide nanoparticles prepared by using the method.

In accordance with another exemplary embodiment of the present invention, there is provided an adsorbent including the mesoporous carbon.

### Advantageous Effects

Mesoporous carbon including iron oxide nanoparticles prepared according to the present invention may exhibit very good adsorption of an organic material and may have advantages in economic factors and convenience due to a reduction in reaction time. Therefore, contaminant treatment efficiency may be maximized by applying the mesoporous carbon including iron oxide nanoparticles according to the present invention to an adsorbent for a water treatment.

### DESCRIPTION OF DRAWINGS

FIG. 1 illustrates a graph showing nitrogen adsorption-desorption isotherms of mesoporous carbon and mesoporous carbon having iron oxide nanoparticles adhered thereto according to an embodiment of the present invention;

FIG. 2 illustrates scanning electron microscope (SEM) micrographs showing surface morphologies of mesoporous carbon and mesoporous carbon having iron oxide nanoparticles adhered thereto according to the embodiment of the present invention;

FIG. 3 illustrates high-resolution transmission electron microscope (TEM) micrographs of mesoporous carbon and mesoporous carbon having iron oxide nanoparticles adhered thereto according to the embodiment of the present invention;

FIG. 4 illustrates X-ray diffraction (XRD) patterns of mesoporous carbon and mesoporous carbon having iron oxide nanoparticles adhered thereto according to the embodiment of the present invention; and

FIG. 5 illustrates a graph showing adsorption removal rates of a natural organic material as a function of reaction time at pH 7 under the presence of each material of mesoporous carbon, mesoporous carbon having iron oxide nanoparticles adhered thereto, and granular activated carbon according to the embodiment of the present invention.

### BEST MODE

Hereinafter, the present invention will be described in more detail.

A method of preparing mesoporous carbon including iron oxide nanoparticles according to an embodiment of the present invention includes (1) dispersing and saturating iron oxide nanoparticles on a surface of mesoporous carbon and (2) calcinating the mesoporous carbon.

In the method of preparing mesoporous carbon including iron oxide nanoparticles according to the present invention, the iron oxide nanoparticles in operation (1) may include one or more selected from the group consisting of Fe₂O₃ and Fe₃O₄.

In the method of preparing mesoporous carbon including iron oxide nanoparticles according to the present invention, operation (1) may be performed by using a dipping method. The dipping method is a method of separately performing synthesis and adhesion of nanoparticles and denotes a method of synthesizing a support having nanoparticles adhered thereto by adhering the dispersed nanoparticles to a surface of the support after synthesizing the nanoparticles. In the method of preparing mesoporous carbon including iron oxide nanoparticles according to the present invention, iron oxide nanoparticles are adhered to a surface of mesoporous carbon by using a dipping method and thus, a surface fouling phenomenon regarded as a typical limitation may be reduced.

The dispersion and the saturation in operation (1) denote that mesoporous carbon is sufficiently immersed in a solution having the prepared iron oxide nanoparticles dispersed therein, and specifically, are characterized in that the mesoporous carbon is dipped in a solution having nano-sized iron oxide dispersed therein.

In the method of preparing mesoporous carbon including iron oxide nanoparticles according to the present invention, operation (2) may be performed at a temperature ranging from 800° C. to 1000° C. under a nitrogen condition.

The calcination in operation (2) denotes that the mesoporous carbon saturated with iron oxide nanoparticles is heated to a high temperature and then cooled again. Specifically, a method of cooling after heating to 900° C. under a nitrogen (N₂) condition may be used in operation (2). Iron oxide nanoparticles are fixed on the surface of the mesoporous carbon due to the calcination.

Also, the present invention provides mesoporous carbon including iron oxide nanoparticles prepared by using the foregoing preparation method.

The mesoporous carbon including iron oxide nanoparticles according to the present invention may not only be useful for water and wastewater treatments due to excellent adsorptivity, but may also be effectively used for various applications, because the mesoporous carbon including iron oxide nanoparticles may be suitable for a catalytic oxidation process due to iron oxide.

In the mesoporous carbon including iron oxide nanoparticles according to the present invention, the iron oxide nanoparticles may have a uniform particle diameter ranging from 5 nm to 50 nm. A particle size of metal oxide, such as nano-sized iron oxide and titania, prepared by using a typical method of impregnating a support in a metal ion solution is not uniform and irregular-shaped particles having various sizes are formed during calcination. However, since the mesoporous carbon including iron oxide nanoparticles according to the present invention is prepared by a dipping method, uniform nano-sized iron oxide particles may be adhered to the surface of the mesoporous carbon.

Also, the present invention may provide an adsorbent including the mesoporous carbon.

The mesoporous carbon including iron oxide nanoparticles according to the present invention may exhibit very good adsorption of an organic material and may have advantages in economic factors and convenience due to a reduction in reaction time. Therefore, contaminant treatment efficiency in a typical water treatment process may be maximized by using excellent performance of the mesoporous carbon including iron oxide nanoparticles according to the present invention.

Hereinafter, the present invention will be described in detail, according to specific examples. However, the following examples are merely provided to allow for a clearer understanding of the present invention, rather than to limit the scope thereof.

### EXAMPLES

### Example 1

### Preparation of Mesoporous Carbon having Iron Oxide Nanoparticles Adhered Thereto

Tetraethylorthosilicate (TEOS) was used as a silica template material and mesoporous carbon was prepared by using a hard-template method (Kim et. a., 2004).

Also, iron oxide nanoparticles (Sigma-Aldrich, particle diameter of 50 nm or less) was purchased and used.

Iron oxide nanoparticles were adhered to a surface of the prepared mesoporous carbon by using a dipping method.

Iron oxide nanoparticles were uniformly dispersed on the surface of the mesoporous carbon by using a sonicator and thus, phenomena of nanoparticle agglomeration and pore blocking of a support by nanoparticles were reduced. Iron oxide nanoparticles were effectively adhered by repeating the foregoing process. Thereafter, samples were prepared by drying at 100° C. and then calcinating at 900° C. in a nitrogen atmosphere.

### Experimental Example

### (1) Natural Organic Material Adsorption/Removal Reaction of Mesoporous Carbon

A natural organic material was selected as a target organic material in order to perform adsorption experiments. The reason for this is that the natural organic material was formed of molecules having various sizes (1 to 1,000,000 Dalton) and iron oxide nanoparticles as well as mesoporous carbon had adsorptivity thereto. Granular activated carbon (GAC) typically used in a water treatment process was selected as a control group in order to compare performances of the samples. 50 ml of a solution of the natural organic material (IHSS, Suwannee River) having an initial concentration of 10 mg/l and each adsorbent were introduced into a reactor and batch adsorption experiments were conducted. The solution was maintained at pH 7 and was continuously stirred at 200 rpm at a temperature of 25° C. The solution was sampled at a predetermined time interval in order to analyze a concentration of the natural organic material.

### (2) Characterization Methods

Brunauer, Emmett, and Teller (BET) surface area and pore volume were analyzed by using a surface area and porosimetry analyzer (Micrometrics ASAP 2020) in order to investigate surface physical properties of the adsorbents. Surface morphologies of the samples were investigated by using a field emission scanning electron microscope (FE-SEM, Hitachi S-4700) and surface elemental analysis was performed by using an energy-dispersive X-ray analyzer (EDX, Horiba). A high-resolution transmission electron microscope (HR-TEM, Jeol JEM-2100) was used to obtain information on particle size and surface morphology. Also, X-ray diffraction (XRD) patterns were obtained by using an X-ray powder diffractometer (Rigaku D/Max Ultima III) with Cu/Ka radiation (λ=1.54056 Å).

### (3) Absorbent Property Analysis

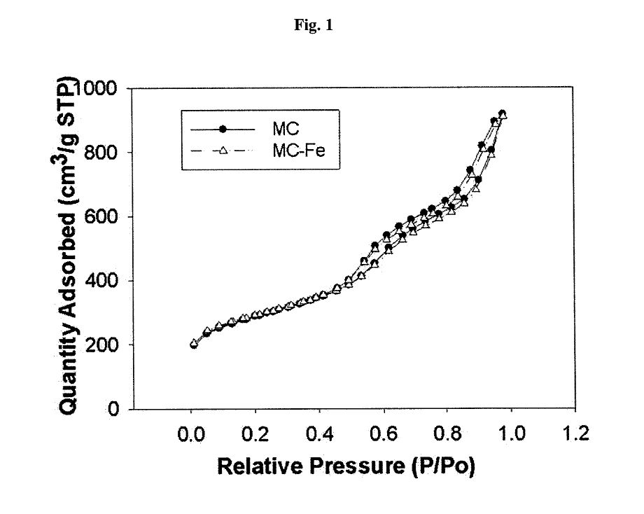

Physical properties of mesoporous carbon (MC) and mesoporous carbon having iron oxide nanoparticles adhered thereto (MC—Fe) are presented in the following FIG. 1 and Table 1. The mesoporous carbon having iron oxide nanoparticles adhered thereto was classified as type 4, H3 according to the International Union of Pure and Applied Chemistry (IUPAC) definition and thus, major pores were mesoporous pores. Since a pore shape was not changed even after the adhesion of iron oxide nanoparticles, it may be confirmed that physical properties thereof were not changed.

Also, BET surface areas and pore volumes were calculated through nitrogen adsorption-desorption isotherms and the results thereof are presented in Table 1. When compared with mesoporous carbon, it may be confirmed that physical properties of mesoporous carbon having iron oxide nanoparticles adhered thereto were not changed. The reason for this is that a pore blockage phenomenon of mesoporous carbon by iron oxide nanoparticles was reduced by using the dipping method, and it may be considered as a phenomenon due to the carburization of the existing pores during the calcination at 900° C.

TABLE 1

| | BET surface area (m²/g) | Pore volume (cm³/g) |
|---|---|---|
| MC | 960.06 | 1.42 |
| MC-Fe | 964.53 | 1.41 |

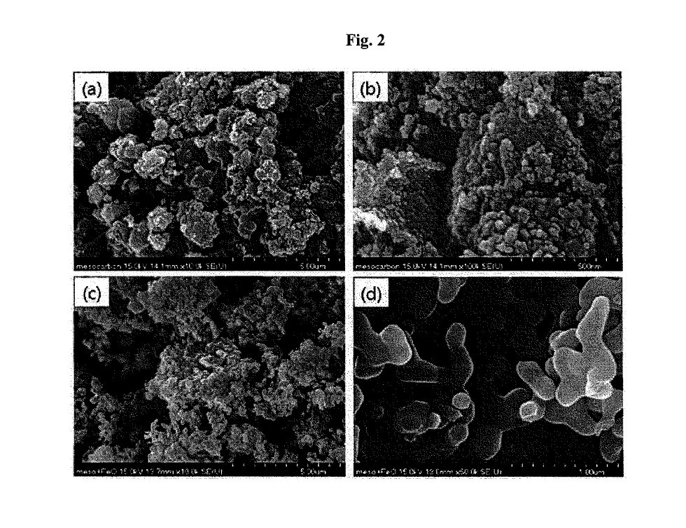

SEM micrographs were taken in order to visually investigate surface morphologies of mesoporous carbon and mesoporous carbon having iron oxide nanoparticles adhered thereto. FIGS. 2(a) and 2(b) illustrate mesoporous carbon before being used as a support. It may be confirmed in FIGS. 2(c) and 2(d) that iron oxide nanoparticles were adhered to the surface of mesoporous carbon and the iron oxide nanoparticles had the shape of a peanut when calcinated at a temperature of 900° C. FIGS. 2(a) and 2(b) are SEM images of initial mesoporous carbon and FIGS. 2(c) and 2(d) are SEM images of mesoporous carbon having iron oxide nanoparticles adhered thereto. Surface elemental analysis was performed by EDX analysis (Table 2) and it was confirmed through the presence of an iron component that iron oxide nanoparticles were effectively adhered to the surface of mesoporous carbon.

TABLE 2

| | Surface composition (wt %) | | |
|---|---|---|---|
| | C | O | Fe |
| MC | 68.37 | 31.63 | — |
| MC-Fe | 79.5 | 19.67 | 0.82 |

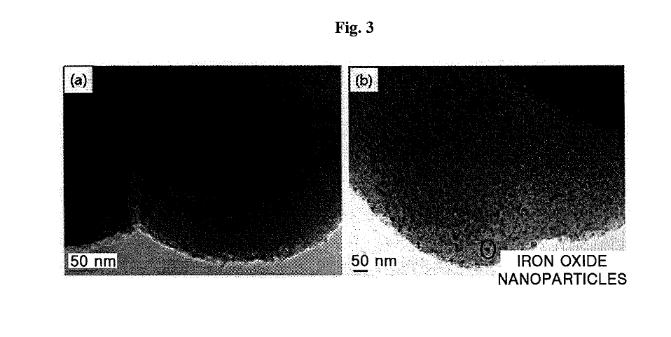

In order to investigate surface morphologies and a size of iron oxide nanoparticles, images were taken through the high-resolution TEM as illustrated in FIG. 3. FIG. 3(a) illustrates mesoporous carbon having irregular pores and FIG. 3(b) illustrates mesoporous carbon having iron oxide nanoparticles adhered thereto. It was confirmed that iron oxide nanoparticles expressed as black dots existed all over the surface and had a uniform particle diameter ranging from 5 nm to 50 nm. It was also observed that an agglomeration phenomenon was reduced by dispersing iron oxide nanoparticles through a dipping method and a sonicator.

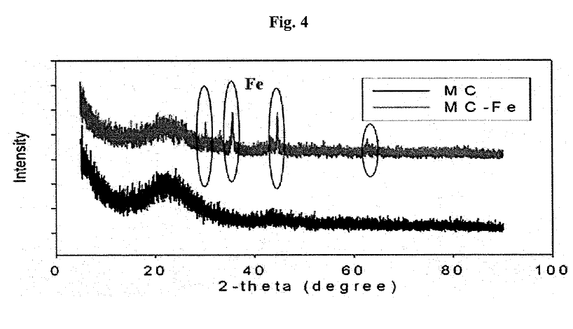

XRD patterns of the synthesized adsorbents are presented in FIG. 4. As illustrated in FIG. 4, with respect to mesoporous carbon having iron oxide nanoparticles adhered thereto, peaks representing iron were observed. It may be confirmed from 2-theta values of 30°, 35°, 57°, and 62° signifying iron oxides (maghemite (γ-Fe₂O₃) and magnetite (Fe₃O₄)) that iron oxide nanoparticles were well adhered to the surface of mesoporous carbon.

### (4) Natural Organic Material Adsorptivity Evaluation of MC—Fe

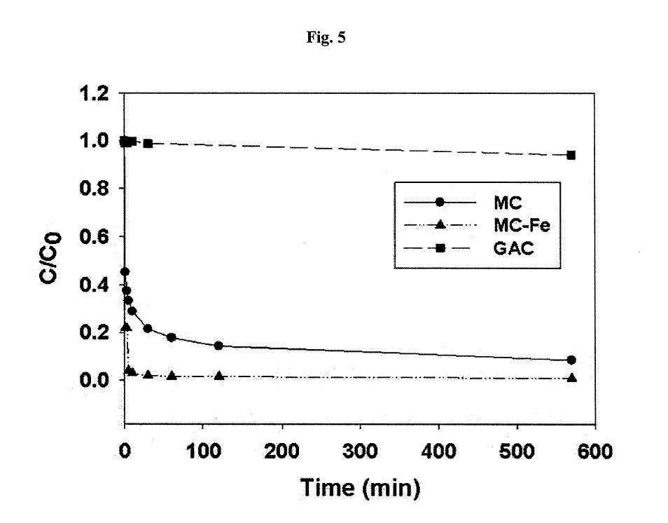

Batch experiments were conducted in order to evaluate natural organic material adsorptivity of mesoporous carbon having iron oxide nanoparticles adhered thereto (MC—Fe). Natural organic material adsorptivity characteristics according to time under the presence of adsorbents are illustrated in FIG. 5. FIG. 5 illustrates a graph showing adsorption removal rates of a natural organic material as a function of reaction time at pH 7 under the presence of mesoporous carbon (), mesoporous carbon having iron oxide nanoparticles adhered thereto (▴), and granular activated carbon (▪) ([NOM]₀=10 mg/L, [adsorbent]=0.25 g/L). It was confirmed that an adsorption equilibrium in the adsorption reaction of MC—Fe was quickly obtained within 10 minutes. When compared with granular activated carbon in which a few hours were required to reach an adsorption equilibrium, the reaction time may be significantly reduced. The reaction was a pseudo second order reaction and pseudo second order reaction rate constants (k) of MC—Fe and granular activated carbon (GAC) were 0.0792 g/mg·min and 0.00225 g/mg·min, respectively. When compared with granular activated carbon, MC—Fe exhibited a reaction rate constant value about 35 times higher than that of the granular activated carbon.

This was resulted from characteristics of mesoporous carbon mainly having mesopores and iron oxide nanoparticles adhered to the mesoporous carbon, in which the mesoporous carbon having pores greater than those of the granular activated carbon having micropores as main pores may facilitate diffusion of the natural organic material having a large molecular weight to enhance adsorption and iron oxide nanoparticles on the surface of the mesoporous carbon additionally adsorbed the natural organic material. Also, when treatment efficiencies were compared, granular activated carbon removed less than 10% of the natural organic material, but MC—Fe exhibited a high removal capacity of 99% or more. It may be understood that a large difference in absorptivities of granular activated carbon and MC—Fe was obtained and it was considered that MC—Fe may effectively remove the natural organic material having a large molecular weight due to physical characteristics, such as a pore size and a pore volume relatively greater than those of the granular activated carbon, and the natural organic material adsorptivity thereof was improved through iron oxide nanoparticles.

Typical mesoporous carbon (MC) exhibited an adsorption removal rate of the natural organic material of 90%, lower than that (99%) of MC—Fe. Also, with respect to the time required to reach an adsorption equilibrium, MC requiring 30 minutes required time longer than that of MC—Fe reaching the reaction equilibrium within 10 minutes. Further, with respect to MC, the second order reaction rate constant was 0.04135 g/mg·min, a value about two times lower than that of MC—Fe. This was a result of iron oxide nanoparticles adhered to the surface of MC—Fe, in which the iron oxide nanoparticles effectively adsorbed the natural organic material. As a result, Mc—Fe had relatively excellent adsorptivity of the natural organic material in comparison to those of the granular activated carbon and typical MC, and Mc—Fe also exhibited excellent reactive power, because the reaction rate constant thereof was respectively 35 times and 2 times or more of those of the granular activated carbon and typical MC.

In the present invention, evaluation of the adsorptivity of mesoporous carbon (MC—Fe) having iron oxide nanoparticles adhered thereto was investigated by adsorption reactions of the natural organic material having various molecular weights. Uniform iron oxide nanoparticles were adhered to the surface of the mesoporous carbon and calcinated at 900° C. According to the surface area and pore analyses, it was found that physical properties were not different from those of typical mesoporous carbon even after iron oxide nanoparticles were adhered to the synthesized adsorbent. Also, iron oxide nanoparticles well dispersed on the surface of the mesoporous carbon were observed in the SEM and TEM images. The XRD analysis indicated that nano-sized iron oxides (maghemite (γ-Fe₂O₃) and magnetite (Fe₃O₄)) were adhered to the synthesized adsorbent. The adsorption experiments of the natural organic material were conducted in a liquid phase at pH 7. The results showed that the mesoporous carbon having iron oxide nanoparticles adhered thereto exhibited adsorption of natural organic material higher than that of when mesoporous carbon was used alone.

As described above, mesoporous carbon having iron oxide nanoparticles adhered thereto was prepared and the adsorptivity thereof as an adsorbent was evaluated in the present invention. The following conclusions were described on the basis of experimental results and discussion.

(1) The XRD and SEM-TEM analyses indicated that MC—Fe was a mixture of iron oxide nanoparticles/mesoporous carbon. Also, the SEM and HR-TEM images indicated that iron oxide nanoparticles were well distributed and adhered to the surface of the mesoporous carbon.

(2) The dipping method used for adhering iron oxide allowed iron oxide nanoparticles to be effectively distributed on the surface of the mesoporous carbon and physical properties of the mesoporous carbon were not changed.

(3) Adsorptivity of mesoporous carbon having iron oxide nanoparticles adhered thereto was evaluated through the removal of the natural organic material. When the removal rates according to reaction time were compared, it was confirmed that the adsorptivity of the mesoporous carbon having iron oxide nanoparticles adhered thereto was significantly increased in comparison to those of granular activated carbon and mesoporous carbon. The reason for this was that physical properties, such as a pore size and a pore volume, of the mesoporous carbon and the iron oxide nanoparticles adhered to the surface of the mesoporous carbon affected an increase in adsorption efficiency of the natural organic material.

1. A method of preparing mesoporous carbon including iron oxide nanoparticles, the method comprising:
(1) dispersing and saturating iron oxide nanoparticles on a surface of mesoporous carbon; and
(2) calcinating the mesoporous carbon.

2. The method of claim 1, wherein the iron oxide nanoparticles in operation (1) comprise one or more selected from the group consisting of Fe₂O₃ and Fe₃O₄.

3. The method of claim 1, wherein operation (1) is performed by using a dipping method.

4. The method of claim 3, wherein the dipping method is performed by dipping mesoporous carbon in a solution having iron oxide nanoparticles dispersed therein.

5. The method of claim 1, wherein operation (2) is performed at a temperature ranging from 800° C. to 1000° C. under a nitrogen condition.

6. Mesoporous carbon including iron oxide nanoparticles prepared by using the method of claim 1.

7. The mesoporous carbon including iron oxide nanoparticles of claim 6, wherein a diameter of the iron oxide nanoparticles is in a range of 5 nm to 50 nm.

8. An adsorbent including the mesoporous carbon of claim 6.

9. The absorbent of claim 8, wherein the absorbent is used for treating contaminants in a water treatment process.
